(19) United States
(12) Patent Application Publication
(10) Pub. No.: US 2009/0266808 A1
(43) Pub. Date: Oct. 29, 2009

(54) PLANAR HEATER AND SEMICONDUCTOR HEAT TREATMENT APPARATUS PROVIDED WITH THE HEATER

(75) Inventors: Kazuo Shibata, Tokyo (JP); Hiroo Kawasaki, Nirasaki-shi (JP)

Correspondence Address: FOLEY AND LARDNER LLP;SUITE 500, 3000 K STREET NW, WASHINGTON, DC, 20007, US

(73) Assignees: COVALENT MATERIALS CORPORATION; TOKYO ELECTRON LIMITED

(21) Appl. No.: 12/441,639

(22) PCT Filed: Aug. 22, 2007
(86) PCT No.: PCT/JP2007/066230

§ 371 Date: Mar. 17, 2009

(30) Foreign Application Priority Data
Sep. 28, 2006 (JP) 2006-264933
Aug. 21, 2007 (JP) 2007-214688

(51) Int. Cl. H05B 3/28

(52) U.S. Cl. 219/444.1; 219/443.1

(57) ABSTRACT

A plane heater and a semiconductor heat treatment apparatus having the heater which suppress high frequency induction heating by having an earth electrode therein for suppressing high frequency induction and do not corrode with an excited reaction gas is provided. A plane heater 1 includes a carbon wire heating element CW arranged and sealed two-dimensionally inside a silica glass plate-like member 2 and an earth electrode 3 arranged and sealed two-dimensionally inside the silica glass plate-like member 2 above the above-mentioned carbon wire heating element CW.

### TECHNICAL FIELD

The present invention relates to a plane heater and a semiconductor heat treatment apparatus having the heater, more particularly relates to a plane heater and a semiconductor heat treatment apparatus having the heater in which a carbon wire heating element and an earth electrode are sealed in a silica glass plate-like member.

### BACKGROUND ART

The present applicants proposed a plane heater having a carbon wire heating element sealed in a silica glass plate-like member as shown in Patent Document 1 (Japanese Patent Application Publication No. 2000-173750). The plane heater having the carbon wire heating element can be suitably used in a semiconductor manufacturing industry due to a small amount of impurity diffusion.

It is to be noted that with regard to apparatuses for use in the semiconductor manufacturing industry, there are apparatuses for processing a semiconductor (wafer) in a plasma atmosphere such as a plasma CVD apparatus, a plasma etching apparatus or the like. Among these apparatuses, for example, the plasma CVD apparatus has a characteristic such that an energy necessary for activation of reaction is obtained by plasma and a film can be formed at low substrate temperatures of approximately 200° C. to 400° C.

For this plasma CVD apparatus, a plasma CVD apparatus shown in Patent Document 2 (Japanese Patent Application Publication No. 2000-178749) is shown as FIG. 7, and this plasma CVD apparatus will be described with reference thereto.

This plasma CVD apparatus 100 is provided with a vacuum-evacuable reactor (chamber) 101, a stage 102 disposed in the reactor 101, film-forming gas supply systems 103 and 104 for supplying a film-forming gas into the reactor 101, a plasma generating system comprising high frequency power supply units 106 and 107 for generating plasma 105 in the reactor 101 and an antenna 108, a substrate heater 109 disposed at the stage 102, a heater power source 109A for supplying electrical power to the substrate heater 109 and a substrate mounting sheet 110 on a surface of which a substrate W to be processed can be placed and which disposed on a stage 102

Further, the above-mentioned reactor 101 is provided with a vacuum exhaust system (vacuum pump) 111 such as an oil-sealed rotary pump, a mechanical booster pump or the like and configured to depressurize the inside of the reactor 101 to a predetermined pressure.

In more detail, the above-mentioned stage 102 is provided at upper ends of insulating support pipes 102A in the center inside the reactor 101. This stage 102 is made of metal and the above-mentioned substrate heater 109 is disposed at the bottom of the stage 102. The substrate heater 109 is electrically connected with the heater power source 109A. This substrate heater 109 is configured to heat the substrate W to be processed with electrical power supplied from the heater power source 109A, through the stage 102 and the substrate mounting sheet 110 respectively.

Next, an operation of this plasma CVD apparatus will be described. Firstly, evacuation of the reactor 101 is started after mounting the substrate W to be processed on the metallic stage 102 disposed inside the reactor 101 of the plasma CVD apparatus. Then, at the time of completion of pressure reduction to a predetermined pressure, electricity is supplied to the substrate heater 109 mounted inside the metallic stage 102 so as to raise a temperature of the substrate W to be processed to a predetermined temperature with this substrate heater 109 through the metallic stage 102.

Next, a predetermined reaction gas is supplied into the reactor (chamber) 101. High frequency electrical power is then provided to the metallic stage 102 in the reactor 101 and the antenna (opposite electrode) 108 respectively so as to form a predetermined film on the substrate W to be processed by generating plasma and causing CVD reaction between the metallic stage 102 and the antenna (opposite electrode) 108.

[Patent Document 1] Japanese Patent Application Publication No. 2000-173750

[Patent Document 2] Japanese Patent Application Publication No. 2000-178749

### DISCLOSURE OF THE INVENTION

### Problems to Be Solved by the Invention

Incidentally, in the case where a substrate heater used in a conventional apparatus for processing a semiconductor (wafer) in a plasma atmosphere such as a plasma CVD apparatus, plasma etching apparatus or the like is formed of a conductive material such as metal or carbon, it is difficult to control a temperature of the heater itself because high frequency induction by high frequency wave for producing plasma causes heat generation.

Further, although the above-mentioned substrate heater is arranged out of the generation area of plasma (out of area between the metallic stage and the opposite electrode), there is a problem that the substrate heater is corroded because an excited reaction gas is flowed down and contacts with the substrate heater.

The present inventors have diligently performed research and development paying attention to the heater using the carbon wire heating element as one method of solving the above-mentioned technical problem. As a result, the inventors have come to find a plane heater which suppresses high frequency induction heating by having an earth electrode therein for suppressing high frequency induction and does not corrode with an excited reaction gas, and have completed a plane heater in accordance with the present invention.

The present invention is made in order to solve the above-mentioned technical problem, and aims at providing a plane heater and a semiconductor heat treatment apparatus having the heater which suppress high frequency induction heating by having an earth electrode therein for suppressing high frequency induction and do not corrode with an excited reaction gas.

### Means to Solve the Problem

The plane heater in accordance with the present invention made in order to attain the above-mentioned object is a plane heater including a carbon wire heating element arranged and sealed two-dimensionally inside a silica glass plate-like member and an earth electrode arranged and sealed two-dimensionally inside the silica glass plate-like member above the above-mentioned carbon wire heating element.

Thus, since the carbon wire heating element and the earth electrode are sealed inside the silica glass plate-like member, high frequency induction heating can be suppressed and corrosion of the carbon wire heating element and the earth electrode caused by an excited reaction gas can be suppressed.

Now, it is desirable that the above-mentioned carbon wire heating element is accommodated in a groove formed at a bottom face of a silica glass plate-like member and the above-mentioned earth electrode is accommodated in a recess formed at a top face of the above-mentioned silica glass plate-like member, and other silica glass plate like members are fused to the top and bottom faces of the above-mentioned silica glass plate-like member to seal the above-mentioned carbon wire heating element and the above-mentioned earth electrode inside the silica glass plate-like member.

By employing such a structure, the carbon wire heating element and the earth electrode can easily be sealed inside the silica glass plate-like member.

Further, it is desirable that a plurality of projections are formed inside the above-mentioned recess, and the above-mentioned earth electrode is formed of a carbon material and a plurality of through holes are formed therein at predetermined intervals, and the projections formed inside the above-mentioned recess are inserted through the through holes of the above-mentioned earth electrode. In particular, it is desirable that the above-mentioned carbon material is a carbon sheet having a thickness of 1 mm or less.

By employing such a structure, expansion and breakage of the earth electrode can be suppressed.

Furthermore, it is desirable that a difference between a fusion-bonding area for bonding the top face of the above-mentioned silica glass plate-like member to the other silica glass plate-like member and a fusion-bonding area for bonding the bottom face of the above-mentioned silica glass plate-like member to the other silica glass plate-like member is 8% or less.

By employing such a structure, the silica glass plate-like member and the other silica glass plate-like members are fully fused together and become an integral silica glass plate-like member.

Further, it is desirable that a connection wire connected with the above-mentioned earth electrode is connected electrically by crimping the connection wire to the bottom face of the earth electrode. Further, it is desirable that a knot is formed on the connection wire connected with the above-mentioned earth electrode, and the above-mentioned knot is crimped to the bottom face of the earth electrode.

By employing such a structure, an external force applied to the silica glass plate-like member can be suppressed and a more complete electrical connection can be obtained.

It should be noted that, it is desirable that the above-mentioned plane heater is applied to a semiconductor heat treatment apparatus.

According to the present invention, it is possible to obtain the plane heater which can suppress high frequency induction heating by having the earth electrode therein for suppressing high frequency induction, and can suppress corrosion caused by the excited reaction gas by having the earth electrode and the carbon wire heating element sealed therein. Further, it is possible to obtain the semiconductor heat treatment apparatus having the heater.

### BRIEF DESCRIPTION OF THE DRAWINGS

FIG. 1 is a schematic sectional view showing a plane heater in accordance with a preferred embodiment of the present invention.

FIG. 2 is a view taken along a line A-A shown in FIG. 1.

FIG. 3 is a view taken along a line B-B in FIG. 1.

FIG. 4 is a bottom view of FIG. 1.

FIG. 5 is an enlarged view of a center area (area D) of a heater in FIG. 3.

FIG. 6 is an enlarged view of an area C shown in FIG. 1.

FIG. 7 is a schematic diagram of a plasma CVD apparatus.

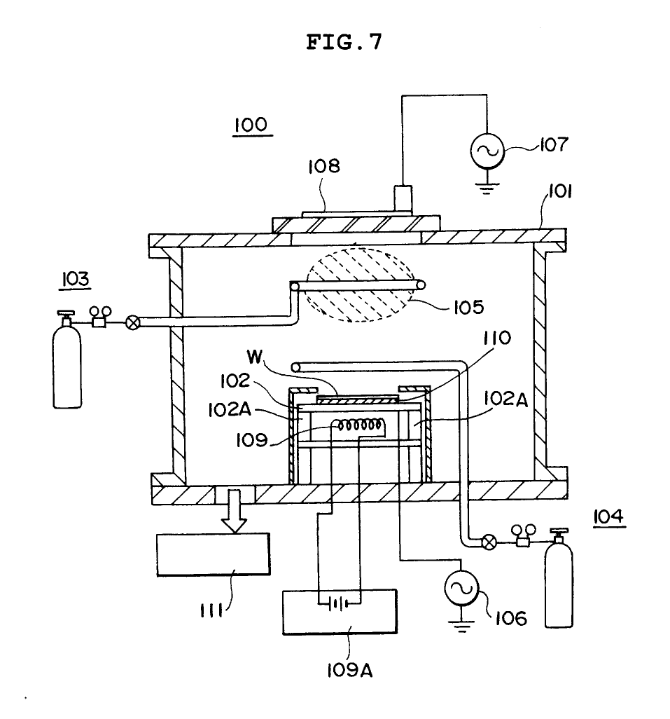

### DESCRIPTION OF REFERENCE SIGNS

1 plane heater
1a heating surface
2 silica glass plate-like member
21 first silica glass member
22 second silica glass member
23 third silica glass member
22d groove
22e groove
22f groove
3 earth electrode
4a connection wire
4b connection wire
5a connection wire
5b connection wire
6 connection wire for earth electrode
10 power supply terminal portion
11 silica glass pipe
12 silica glass pipe
13 silica glass pipe
14 silica glass pipe
15 silica glass pipe
16 silica glass pipe of large diameter
CW carbon wire heating element
CW1 carbon wire heating element in inner area (right side)
CW2 carbon wire heating element in inner area (left side)
CW3 carbon wire heating element in outer area (right side)
CW4 carbon wire heating element in outer area (left side)
T knot

### BEST MODE FOR IMPLEMENTING THE INVENTION

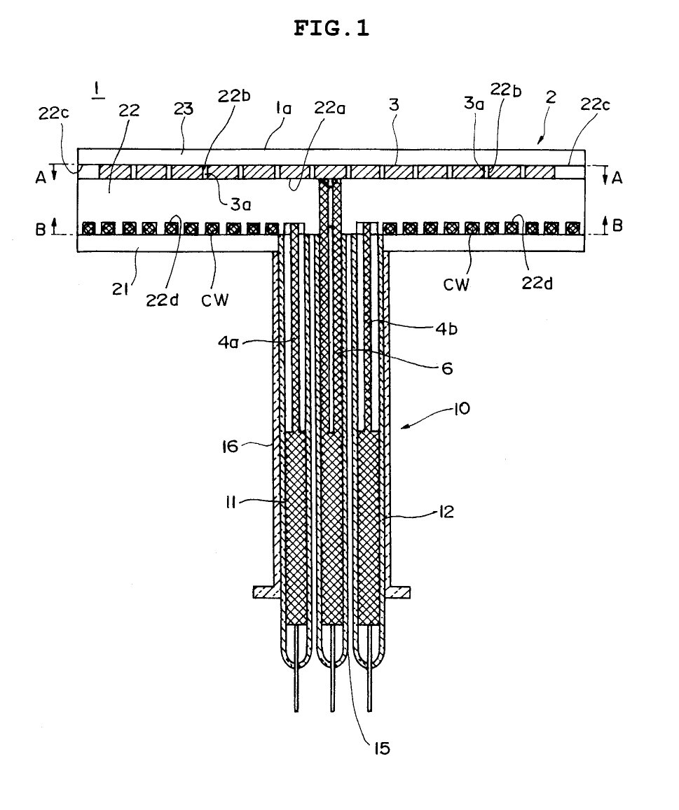

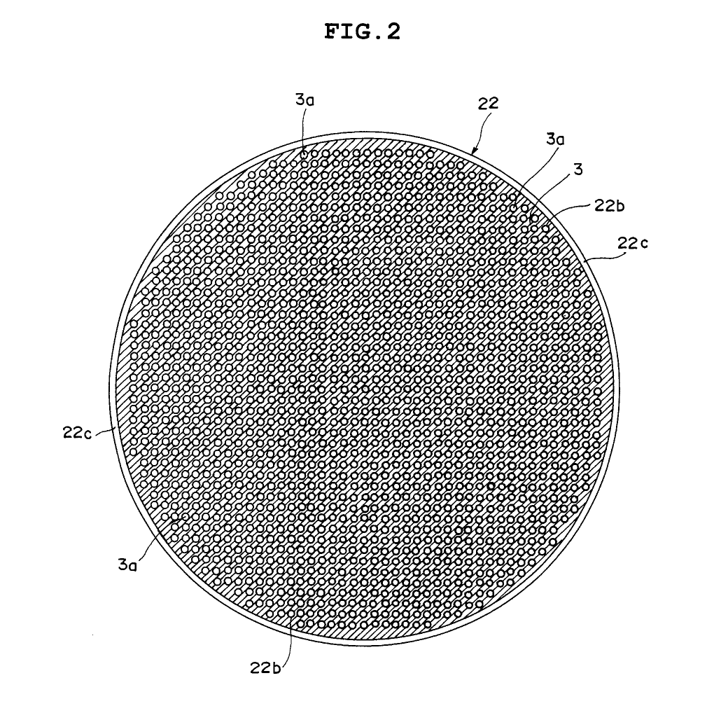

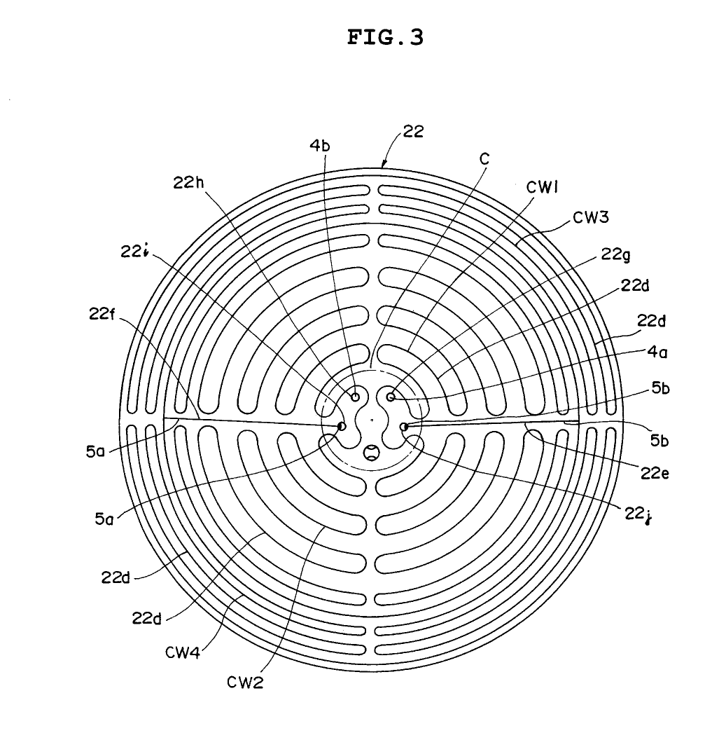

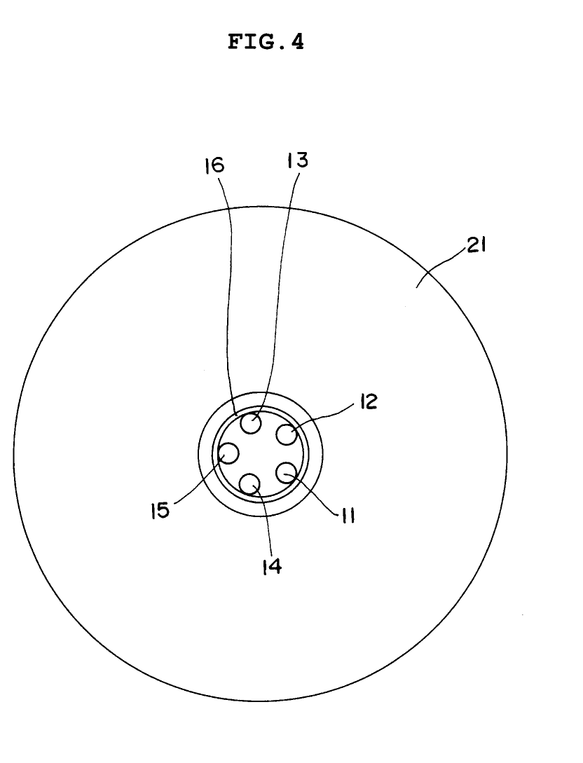

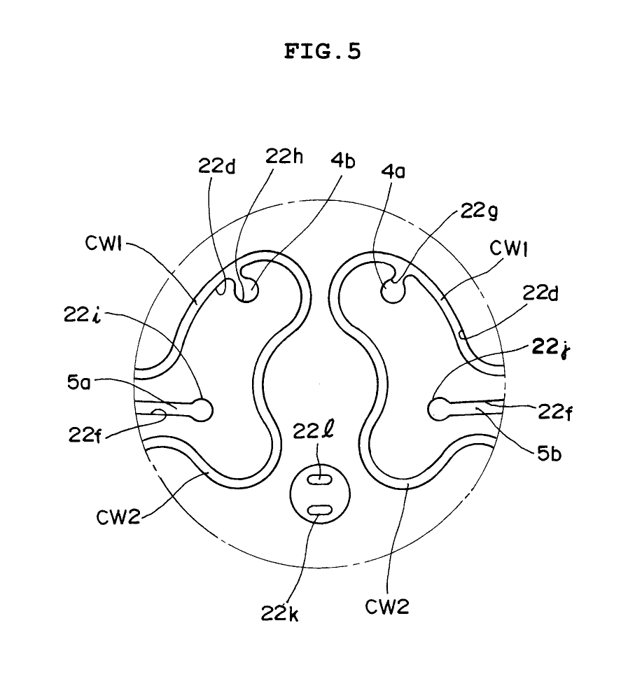

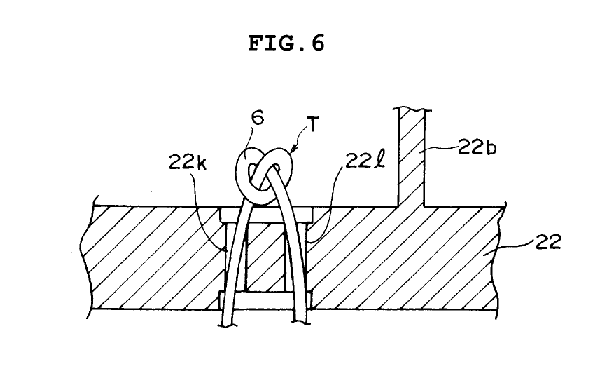

Hereinafter, a preferred embodiment in accordance with the present invention is described with reference to FIGS. 1 through 6. It should be noted that FIG. 1 is a schematic sectional view showing a plane heater in accordance with a preferred embodiment of the present invention, FIG. 2 is a view taken along a line A-A shown in FIG. 1, FIG. 3 is a view taken along a line B-B in FIG. 1, FIG. 4 is a bottom view of FIG. 1, FIG. 5 is an enlarged view of a center area (area C) of the heater in FIG. 3 and FIG. 6 is a view showing a knot to be connected with an earth electrode.

As shown in FIG. 1, as for this plane heater 1, a heating surface 1a is formed in the shape of a circular plate, and an earth electrode 3 and a carbon wire heating element CW are enclosed within a silica glass plate-like member 2.

The above-mentioned silica glass plate-like member 2 is constituted by a first silica glass member 21, a second silica glass member 22, and a third silica glass member 23.

The above-mentioned carbon wire heating element CW is enclosed between the first silica glass member 21 and the second silica glass member 22, and the above-mentioned earth electrode 3 is enclosed between the second silica glass member 22 and the third silica glass member 23.

It should be noted that by “a carbon wire heating element and an earth electrode are sealed or enclosed” in the present invention is meant that the carbon wire heating element and earth electrode are hermetically sealed so as not to be exposed to open air.

Further, the structure of this plane heater 1 will be described. An accommodation portion 22a for accommodating the earth electrode 3 is formed in the shape of a recess at the top face of the second silica glass member 22.

This earth electrode 3 is formed in the shape of a circular plate, a material thereof is preferably a carbon material in terms of an electrical mobility, ease of manufacturing and coefficient of thermal expansion, and more preferably using a carbon sheet having a thickness of 1 mm or less. The best mode embodiment is a graphite seal with an electrical resistance anisotropy ratio of the thickness direction to the planar direction (thickness direction/planar direction) of 2 or more. The preferred value for the electrical resistance is 20×10⁻⁶Ω·m or less in the thickness direction and 10×10⁻⁶Ω·m or less in the planar direction.

Further, the above-mentioned earth electrode 3 is arranged such that a number of through holes 3a are formed at predetermined intervals as shown in FIG. 2 and projections 22b formed in the above-mentioned accommodation portion 22a are inserted into the above-mentioned through holes 3a. It should be noted that, although it is not shown in the drawing, a diameter of the above-mentioned through hole 3a is formed larger than a diameter of the projection 22b, and a clearance is formed between the above-mentioned through hole 3a and projection 22b.

A number of through holes 3a are thus formed in order to prevent a bulge and breakage due to thermal expansion of the earth electrode 3. The bulge is a phenomenon in which, the earth electrode 3 is enclosed within the silica glass member so that expansion is restricted and thereby resulting in curvature of the earth electrode 3. The breakage is a phenomenon in which the curvature of the above-mentioned earth electrode 3 reaches to the limit, thereby resulting in breakage of the earth electrode 3.

Then, the earth electrode 3 is accommodated in the accommodation portion 22a having the shape of a recess formed at the top face of the second silica glass member 22, and the second silica glass 22 and the third silica glass 23 are fused together so that the above-mentioned earth electrode 3 is enclosed between the second silica glass member 22 and the third silica glass member 23.

It should be noted that a contact area of the above-mentioned second silica glass 22 with the third silica glass 23 becomes a fusion-bonding area for bonding the second silica glass member 22 to the third silica glass member 23. In other words, the sum total of the area 22c that is the top face of the outer edge area being outside of the above-mentioned accommodation portion 22a and the area of the top face of the above-mentioned projection 22b becomes the fusion-bonding area for bonding the second silica glass member 22 to the third silica glass member 23.

Further, grooves 22d having the same shape as the arrangement pattern shown in FIG. 3 and grooves 22e and 22f extending from the center in the diameter direction are provided at the bottom face of the second silica glass member 22.

In this plane heater, the heating surface (heater surface) 1a is divided into four areas. In other words, the carbon wire heating elements CW1, CW2, CW3 and CW4 are arranged at each of the areas obtained by halving the inner area of the heater surface and further halving the outer area located in the periphery of the inner area.

Further, as shown in FIGS. 3 and 5, circular-shaped recesses 22g, 22h, 22i and 22j are formed at the bottom center of the second silica glass member 22. These recesses 22g and 22h are communicated with the groove 22d in the inner area. On the other hand, the recesses 22i and 22j are communicated with the groove 22d in the outer area through the grooves 22e and 22f.

It should be noted that, in FIG. 3, the grooves 22d, 22e and 22f are shown with a line but in FIG. 5, these are shown as grooves having widths.

Then, in a first area in the inner area (right inner area of FIG. 3), the carbon wire heating element CW1 is accommodated in the groove 22d formed in the right inner side. In a second area in the inner area (left inner area of FIG. 3), the carbon wire heating element CW2 is accommodated in the groove 22d formed in the left inner side.

Further, in a third area in the outer area (right outer area of FIG. 3), the carbon wire heating element CW3 is accommodated in the groove 22d formed in the right outer side. In a forth area in the outer area (left outer area of FIG. 3), the carbon wire heating element CW4 is accommodated in the groove 22d formed in the left outer side.

Further, as shown in FIGS. 1 and 3, a power supply terminal unit 10 having connection wires 4a, 4b, 5a and 5b for supplying electricity to the above-mentioned carbon wire heating elements CW is provided for the bottom center of the first silica glass member 21. The above-mentioned connection wires 4a and 4b are connection wires for supplying electricity to the inner area, the above-mentioned connection wires 5a and 5b are connection wires for supplying electricity to the center area and a connection wire 6 is a connection wire for connecting with the earth electrode 3. These connection wires 4a, 4b, 5a, 5b and 6 are preferably formed of the carbon wire having the same nature as the above-mentioned carbon wire heating element.

As shown in FIGS. 1 and 4, the above-mentioned connection wire 4a is accommodated in a silica glass pipe 11, and the connection wire 4b is accommodated in a silica glass pipe 12. The silica glass pipes 11 and 12 which accommodate these connection wires 4a and 4b pass through the first silica glass member 21 and are in contact with the bottom face of the second silica glass member 22.

Therefore, the connection wire 4a enters the groove 22d from the silica glass pipe 11 via the recess 22g, and is connected with the carbon wire heating elements CW1 and CW2 in the groove 22d in the inner area. Similarly, the connection wire 4b enters the groove 22d from the silica glass pipe 12 via the recess 22h, and is connected with the carbon wire heating elements CW1 and CW2 in the groove 22d in the inner area.

Although it is not shown in the drawings, the connection wire 5a in the outer area passes via the recess 22i and the groove 22f from a silica glass pipe 13, and is connected with the carbon wire heating element CW3 and the carbon wire heating element CW4 in the groove 22d. Similarly, the connection wire 5b in the outer area passes via the recess 22j and the groove 22e from a silica glass pipe 14 and is connected with the carbon wire heating element CW3 and the carbon wire heating element CW4 in the groove 22d.

Further, as shown in FIGS. 1 and 5, through holes 22k and 22l for the connection wire 6 connected with the earth electrode 3 to be inserted through are formed in the center of the above-mentioned second silica glass member 22. This connection wire 6 is inserted through the through hole 22k from a silica glass pipe 15, formed into a knot T as shown in FIG. 6, inserted through the through hole 22l, and repositioned in the silica glass pipe 15.

Then, electrical connection is made by crimping the knot T to the bottom face of the earth electrode 3. That is, when the second silica glass 22 and the third silica glass 23 are fused together and fixed, the above-mentioned knot T is crimped to the bottom face of the earth electrode 3 and electrical connection is thereby provided.

The knot T formed in this way ensures that, even if there is an error in a compression ratio in the pressing direction in fusing the second silica glass 22 to the third silica glass 23 together, due to change in shape of the knot T, the earth electrode 3 can reliably be in contact with the connection wire 6 without applying external force to the second silica glass 22 and the third silica glass 23. Further, because the knot T is formed, the connection wire 6 does not come off from the through hole 22k when the connection wire 6 is inserted through the through hole 22l and repositioned in the silica glass pipe 15, thereby enhancing productivity.

As described above, the carbon wire heating elements CW1, CW2, CW3 and CW 4 are accommodated in the grooves 22d formed at the bottom face of the second silica glass member 22, and the bottom face of the second silica glass member 22 and the first silica glass member 21 are fused together so that the above-mentioned carbon wire heating elements CW1, CW2, CW3 and CW4 are enclosed between the first silica glass member 21 and the second silica glass member 22.

It should be noted that a contact area of the above-mentioned first silica glass 21 and the second silica glass 22 becomes a fusion-bonding area for bonding the first silica glass member 21 to the second silica glass member 22. In other words, at the bottom face of the second silica glass 22, the area except the groove 22d, groove 22e, groove 22f, and recesses 22g, 22h, 22i and 22j becomes the fusion-bonding area.

Further, the ends of all the silica glass pipes 11, 12, 13, 14 and 15 having accommodated therein the above-mentioned connection wires 4a, 4b, 5a, 5b and 6 are sealed, and accommodated in a silica glass pipe 16 having a large diameter. The silica glass pipe 16 with the large diameter is used as a flange or a shaft for fixing the heater.

Then, in order to manufacture the plane heater 1 having such a structure, in a situation where the carbon wire heating elements CW1, CW2, CW3 and CW4 are accommodated in the grooves 22d of the above-mentioned second silica glass member 22 and connected with each of the connection wires 4a, 4b, 5a and 5b, the first silica glass member 21 and the second silica glass member 22 are fused together to seal the above-mentioned grooves 22d.

Further, the earth electrode 3 is accommodated in the accommodation portion 22a of the second silica glass member 22, and the second silica glass member 22 and the third silica glass member 23 are fused together to seal the above-mentioned accommodation portion (recess) 22a.

Now, it is preferred to perform fusion bonding of the first silica glass member 21 to the second silica glass member 22 and fusion bonding of the second silica glass member 22 to the third silica glass member 23 simultaneously.

By setting the number of times of fusion bonding to one, it is desirable to reduce the number of times for the silica glass to be exposed to high temperature and reduce the probability of occurrence of devitrification caused by recrystallization of silica glass.

It should be noted that, in this case, it is desirable that the difference between the fusion-bonding area for bonding the first silica glass member 21 to the second silica glass member 22 and the fusion-bonding area for bonding the second silica glass member 22 to the third silica glass member 23 is 8% or less.

This is because in the case where there is a difference in the fusion-bonding area, when a pressure is set in relation to the side having a larger fusion-bonding area, the side having a smaller fusion-bonding area is collapsed. Conversely, in the case where a pressure is set in relation to the side having a smaller fusion-bonding area, a portion that is not fused (non-fusion-bonding portion) is formed on the side having the larger fusion-bonding area.

Then, the ends of all the silica glass pipes 11, 12, 13, 14 and 15 having accommodated therein the connection wires 4a, 4b, 5a, 5b and 6 are sealed, and the pipes are accommodated in the silica glass pipe 16 having the large diameter. It should be noted that this sealing structure can be sealed by using a conventionally known pinch seal structure.

In the plane heater 1 constituted in this way, it is possible to suppress high frequency induction heating of the carbon wire heating element CW by having the earth electrode 3 therein for suppressing high frequency induction, perform temperature control of the heater itself easily, and heat the substrate W to be processed with high precision. Further, since the earth electrode 3 and the carbon wire heating element CW are enclosed in the silica glass member 2, they are not in contact with a flowing excited reaction gas and thereby preventing reaction therebetween.

It should be noted that, in the above-mentioned preferred embodiment, the case where the above-mentioned silica glass plate-like member 2 is disk-shaped is described. However, the silica glass plate-like member 2 may be rectangular.

### INDUSTRIAL APPLICABILITY

The plane heater in accordance with the present invention can be used for a semiconductor heat treatment apparatus. More particularly, it can be suitably used as a heater for a CVD apparatus since it suppresses high frequency induction heating by having an earth electrode therein for suppressing high frequency induction and does not corrode with an excited reaction gas.

1. A plane heater comprising a carbon wire heating element arranged and sealed two-dimensionally inside a silica glass plate-like member and an earth electrode arranged and sealed two-dimensionally inside the silica glass plate-like member above said carbon wire heating element, wherein
said carbon wire heating element is accommodated in a groove formed at a bottom face of a silica glass plate-like member and said earth electrode is accommodated in a recess formed at a top face of said silica glass plate-like member, and other silica glass plate-like members are fused to the top face and bottom face of said silica glass plate-like member to seal said carbon wire heating element and said earth electrode inside the silica glass plate-like member, and
a plurality of projections are formed inside said recess and a plurality of through holes are formed in said earth electrode at predetermined intervals, and the projections formed inside said recess are inserted through the through holes of said earth electrode.

2. (canceled)

3. The plane heater as claimed in claim 1, wherein said earth electrode is formed of a carbon material.

4. The plane heater as claimed in claim 3, wherein said carbon material is a carbon sheet having a thickness of 1 mm or less.

5. The plane heater as claimed in claim 1, wherein a difference between a fusion-bonding area for bonding the top face of said silica glass plate-like member to the other silica glass plate-like member and a fusion-bonding area for bonding the bottom face of said silica glass plate-like member to the other silica glass plate-like member is 8% or less.

6. The plane heater as claimed in claim 1, wherein a connection wire connected with said earth electrode is connected electrically by crimping the connection wire to the bottom face of the earth electrode.

7. The plane heater as claimed in claim 6, wherein a knot is formed on the connection wire connected with said earth electrode and said knot is crimped to the bottom face of the earth electrode.

8. A semiconductor heat treatment apparatus comprising the plane heater as claimed in claim 1.

9. A semiconductor heat treatment apparatus comprising the plane heater as claimed in claim 3.

10. A semiconductor heat treatment apparatus comprising the plane heater as claimed in claim 4.

11. A semiconductor heat treatment apparatus comprising the plane heater as claimed in claim 5.

12. A semiconductor heat treatment apparatus comprising the plane heater as claimed in claim 6.

13. A semiconductor heat treatment apparatus comprising the plane heater as claimed in claim 7.
